(19) United States
(12) Patent Application Publication
(10) Pub. No.: US 2002/0146160 A1
(43) Pub. Date: Oct. 10, 2002

(54) Method and apparatus for generating two-dimensional images of cervical tissue from three-dimensional hyperspectral cubes

(76) Inventors: Mary F. Parker, Rockville, MD (US); Gordon S. Okimoto, Honolulu, HI (US); Gregory C. Mooradian, San Diego, CA (US)

Correspondence Address: OFFICE OF THE STAFF JUDGE ADVOCATE, U.S. ARMY MEDICAL RESEARCH AND MATERIEL COMMAND, ATTN: MCMR-JA (MS. ELIZABETH ARWINE), 504 SCOTT STREET, FORT DETRICK, MD, 21702-5012, US

(21) Appl. No.: 10/051,286

(22) Filed: Jan. 22, 2002

Related U.S. Application Data
(60) Provisional application No. 60/262,424, filed on Jan. 19, 2001.

(51) Int. Cl. G06K 9/00

(52) U.S. Cl. 382/131; 382/224; 382/232; 382/154

(57) ABSTRACT

A method and apparatus for generating a two dimensional image of a cervix from a three dimensional hyperspectral data cube includes an input processor constructed to normalize fluorescence spectral signals collected from the hyperspectral data cube. The input processor may be further constructed to extract pixel data from the spectral signals where the pixel data is indicative of cervical tissue classification. The input processor may be further configured to compress the extracted pixel data. A classifier is provided to assign a tissue classification to the pixel data. A two dimensional image of the cervix is generated by an image processor from the compressed data, the two dimensional image including color-coded regions representing specific tissue classifications of the cervix.

This application claims the benefit of U.S. provisional Application Serial No. 60/262,424, filed Jan. 19, 2001, which are all hereby incorporated by reference.

### I. FIELD OF THE INVENTION

This invention relates to detection and diagnosis of cervical cancer. More particularly, this invention relates to methods and devices for generating images of the cervix, which allow medical specialist to detect and diagnose cancerous and pre-cancerous lesions.

### II. BACKGROUND OF THE INVENTION

Cervical cancer is the second most common malignancy among women worldwide, eclipsed only by breast cancer. During the last half century there has been a considerable decline in both the incidence of invasive cervical cancer and in deaths attributable to invasive cervical cancer. However, there has been a substantial increase in the incidence of pre-cancerous lesions such as cervical intraepithelial neoplasia (CIN). The increase in diagnosed pre-cancerous lesions is primarily attributable to two factors, improved screening and detection methods and an actual increase in the presence of cervical pre-cancerous lesions.

CIN is diagnosed in several million women worldwide each year. CIN is a treatable precursor to invasive cervical cancer. The current standard for detecting CIN includes pap smear screening followed by colposcopy and biopsy for diagnosisi by a pathologist. Limitations of this approach, such as low specificity for the pap smear, wide variations in sensitivity and specificity for colposcopy, the need for multiple patient visits, waiting time of several days, soft results, and the requirement for access to a medical specialist with colposcopic training, have prompted the search for alternative methods of screening, detecting, and diagnosing cervical cancer and its precursors.

Recently, researchers have begun to study the application of fluorescence spectroscopy to the diagnosis of CIN. The devices used by these researchers differ in such variables as excitation wavelength(s), type of illumination (laser vs. non-laser), sensor configurations (contact vs. non-contact), spectral analysis (hyperspectral vs. multispectral), and interrogation of a point or region of the cervix versus the entire surface of the cervix. The collective body of research to date suggests that fluorescence spectroscopy is a particularly effective as a diagnostic tool for CIN. Fluorescence spectroscopy relies on the differences in tissue content of fluorophores such as NAD(P)H and collagen, as well as the presence of absorbing, non-fluorescing molecules such as hemoglobin, to discriminate among various types of normal and diseased cervical tissue.

One technique that is particularly effective in detecting and diagnosing CIN is known as hyperspectral diagnostic imaging (HSDI). This method utilizes fluorescence imaging spectroscopy and advanced signal processing and pattern recognition techniques to detect and diagnose CIN and cervical carcinoma in vivo. Devices employing the HSDI method produce hyperspectral data cubes composed of multiple spatially aligned images of the cervix, each image corresponding to one of many spectral channels. However, CIN diagnostic information cannot be easily extracted from hyperspectral cubes in their native format. Accordingly, there is a need for a device and process for extracting diagnostic information from hyperspectral cubes to facilitate the diagnosis and detection of invasive cervical cancer and pre-cancerous lesions.

### III. SUMMARY OF THE INVENTION

The present invention is directed to a method and apparatus for generating a two dimensional histological map of a cervix from a 3-dimensional hyperspectral data cube. The hyperspectral data cube is generated by scanning the cervix. Fluorescence spectra are collected from the hyperspectral data cube and normalized. Components are extracted from the normalized spectra that are indicative of the condition or class of cervical tissue under examination. The extracted components are compressed and assigned a tissue classification. A two dimensional image is generated from the compressed components. The image is color-coded representing a dysplastic map of the cervix.

### IV. BRIEF DESCRIPTION OF THE DRAWINGS

FIG. 1A is a calibrated hyperspectral data cube.

FIG. 1B depicts a spatial image associated with a spectral band.

FIG. 1C illustrates the fluorescence spectrum associated with a pixel (x, y).

FIG. 2 is a block diagram of a system in accordance with the invention.

FIG. 3 is shows fluorescence spectra for CIN1 and normal squamous tissue from a single patient.

FIG. 4 shows the fluorescence spectra for CIN1 for three different individuals.

FIG. 5A depicts mean CIN1 fluorescence spectra for two individuals before area normalization.

FIG. 5B illustrates mean CIN1 fluorescence spectra for the two patients of FIG. 5A after area normalization.

FIG. 6 is a graph showing the mother wavelet function and the mother wavelet function scaled by 5 and translated by 10.

FIG. 7A illustrates a scalogram for CIN1.

FIG. 7B illustrates a scalogram for normal squamous tissue.

FIG. 8A depicts a wavelet vector for CIN1.

FIG. 8B shows a wavelet vector for normal squamous tissue.

FIG. 8C illustrates a difference between the CIN1 and squamous vectors.

FIG. 9A shows eigenvalues of the wavelet data matrix.

FIG. 9B depicts the top 15 PWC features for typical CIN1.

FIG. 10A shows two dimensional color-coded image of entire cervix.

FIG. 10B shows a histological map for CIN1.

### V. DETAILED DESCRIPTION OF THE EMBODIMENTS

The present invention is directed to a method for transforming 3-dimensional hyperspectral data cubes into 2-dimensional color coded images of the cervix, i.e., a histological map of the cervix. The United States Department of the Army has sponsored a substantial research effort to design a non-invasive device for detection and diagnosis of cancerous and pre-cancerous conditions, e.g., CIN. As part of the research effort, a proprietary non-contact hyperspectral diagnostic imaging (HSDI) device has been developed that scans the surface of the cervix with ultraviolet light, and simultaneously collects and analyzes the fluorescence emissions to discriminate among various types of normal and dysplasic cervical tissue.

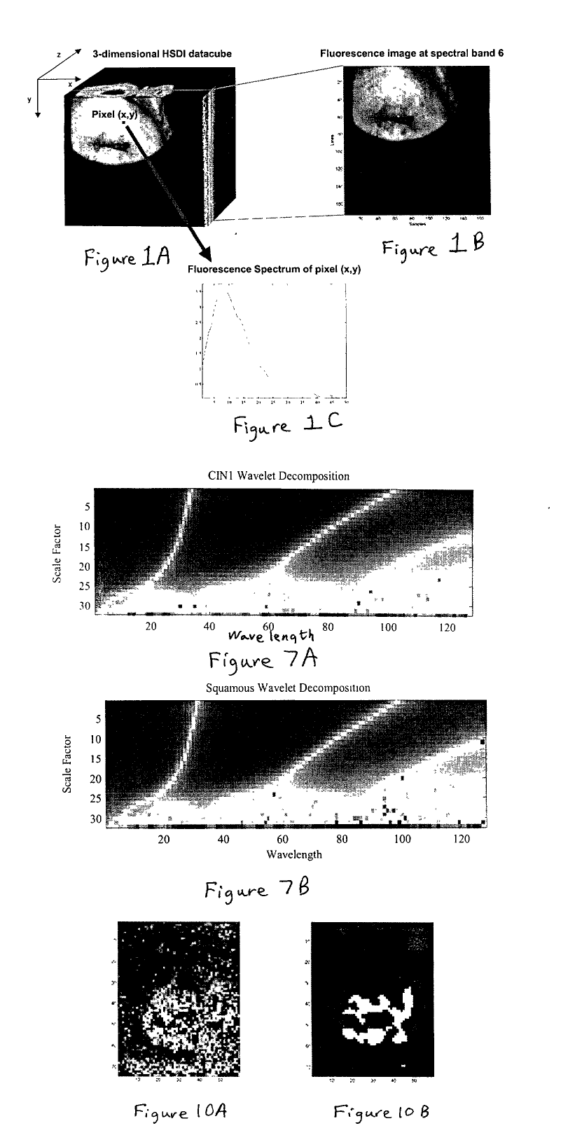

The proprietary HSDI device employs a spectrometer that, in operation, is focused on a portion of the cervix preferably at a spot located approximately 1 cm above the cervical OS. A 1.2 mm wide beam of UV light having a wavelength of about 365 nm is generated by a mercury vapor lamp and scanned, preferably line by line, top to bottom, over an approximately 40 mm×40 mm area of the surface of the cervix using a pushbroom imager. Fluorescent light patterns in the 400-770 nm range are collected by the imaging spectrometer which produces a 3-dimensional hyperspectral data cube composed of 50 spatially aligned fluorescence images of the cervix, each image measuring approximately 172×172 pixels. Each 172×172 image represents the spatial information in the data cube that corresponds to the x-y variation of fluorescence intensity over the surface of the cervix within a narrow band of wavelengths about 7.4 nm wide. Conversely, a spectral profile (along the z-axis) is associated with each pixel of the data cube showing how fluorescence energy within a 0.05 mm² area on the cervix is distributed over the 50 spectral channels. FIG. 1A illustrates a data cube having a pixel at spatial location (x, y); FIG. 1B illustrates the spatial image at spectral band 6, and FIG. 1C illustrates the fluorescence spectrum associated with pixel (x, y). The present invention is directed to an improved method and apparatus for determining the tissue class of the area (corresponding to a pixel) by analyzing its spectrum.

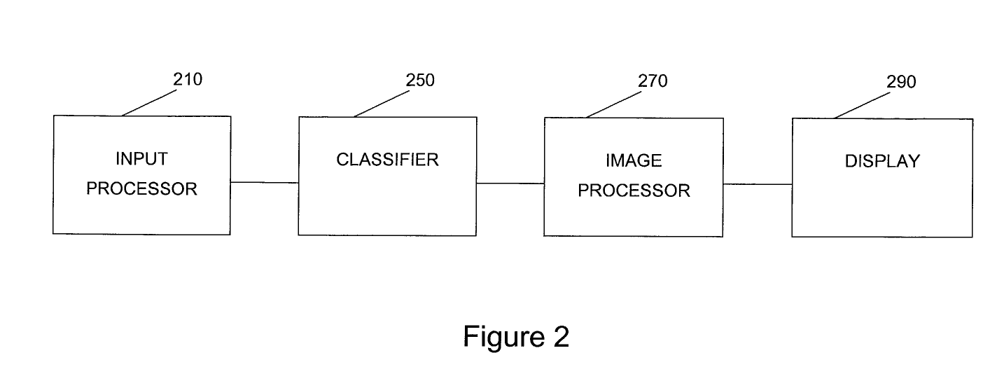

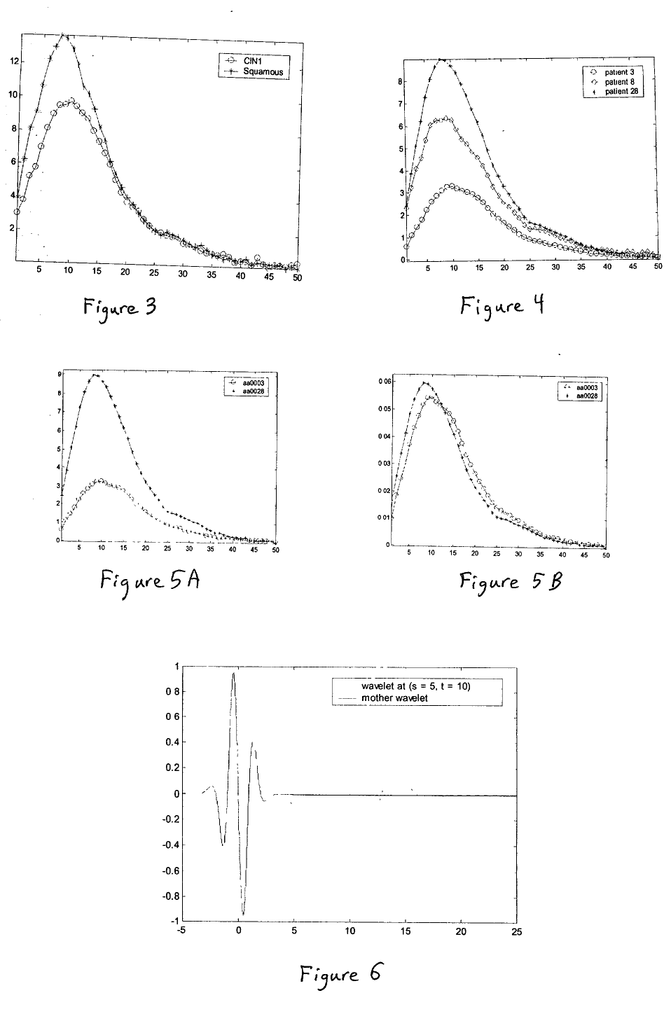

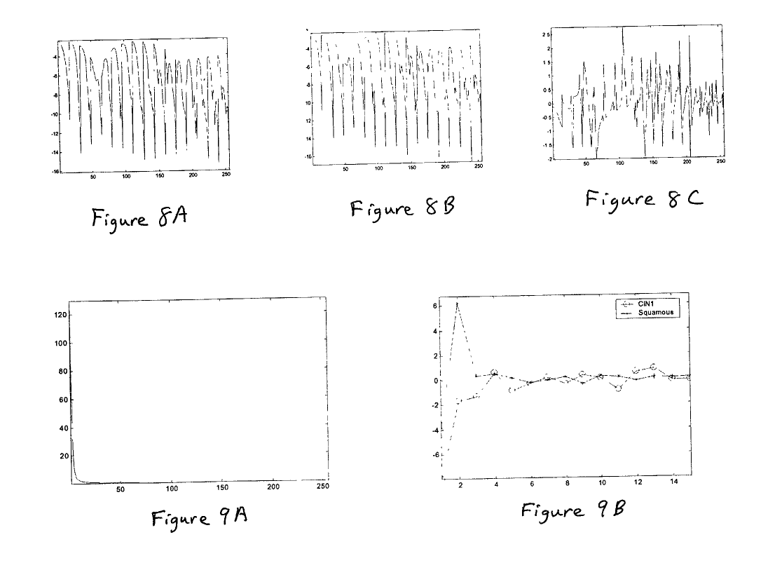

FIG. 2 illustrates an exemplary system in accordance with the invention. An input processor 210 is depicted in communication with a classifier 250 that, in turn, is in communication with an image generator 270 that communicates with a display 290. Input processor 210 analyzes each pixel of the data cube by extracting characteristics of the pixel spectra and compressing the extracted characteristics. The compressed characteristics are then sent to classifier 250 that classifies each pixel according to cervical tissue class. In preferred embodiments, the classifier comprises a neural network. Potential classifications include, but are not limited to: (i) CIN1, (ii) CIN2, (iii) CIN3, (iv) squamous cell carcinoma, (v) adenomatous neoplasia including adenocarcinoma-in-situ and invasive adenocarcinoma, (vi) normal squamous tissue, (vii) normal columnar tissue, and (viii) normal metaplasia. In addition, a category of “other” is included to encompass a category of data that does not fall within any of the foregoing tissue classifications. Image generator 270 then constructs a two dimensional image of the cervix with the pixels that is color-coded based on the tissue classification output from classifier 250. This 2-dimensional image may be further filtered by image generator 270 to form a histological map showing the distribution of different tissue classes over the entire surface of the cervix.

In keeping with the invention, any one or more of the following system components, input processor 210, the classifier 250 and the image processor 270, may be realized in hardware or software. More particularly, any one or more of the system components may comprise a microchip, hardwired or programmed to perform functions described herein. Further, any one or more of the system components may comprise program code for causing a computing device, e.g. a processor or computer, to perform the functions described herein. The program code may be embodied in a computer readable medium such as a storage element or a carrier wave. Suitable storage elements include CD ROMs, floppy disks, smart tokens, etc. Although not explicitly disclosed given the functional description set forth herein, suitable program code instructions may be generated by the skilled artisan without undue experimentation.

In keeping with the general operative aspects of the invention, input processor 210 extracts characteristics of the data cube and compresses those extracted characteristics for input to classifier 250 that discriminates pixels and determines their tissue class membership. It has been determined that subtle shape characteristics of the spectra of each pixel strongly influence tissue class membership. Indeed, the spectral “hump” that is characteristic of HSDI spectral data (FIG. 1C) contains some useful global information such as peak magnitude and shifts of peak magnitude over wavelength. But numerical experiments based on clinical data have shown that most of the discriminatory information is local in nature and lie in the tiny undulations that ride on top of the spectral hump at multiple scales of resolution.

FIG. 3 illustrates the differences between spectra for CIN1 and normal squamous tissue from a single patient. The most obvious difference between the spectra in FIG. 3 is the lower peak magnitude of the CIN1 spectrum. Note also a slight shift in peak magnitude towards the higher wavelengths for CIN1. Unfortunately, while peak magnitude is somewhat discriminatory on an intra-patient basis, it is less so when used to discriminate on an inter-patient basis due to large statistical variations of peak magnitude between patients. The value of a shift in peak magnitude as a discriminatory cue is similarly compromised by large variations in peak magnitude. FIG. 4 shows the variation in mean peak magnitude for CIN1 between three different patients. It is evident that global features such as peak magnitude are not invariant enough over multiple patients to serve as effective discriminators for low-grade cervical dysplasia. Moreover, the variation of such features threatens to swamp the smaller but more important local variations that lie embedded in the spectral background. Accordingly, based on the foregoing, it is believed that normalization of the spectra are needed to mitigate the negative impact of large variations in peak magnitude seen in HSDI data and to accentuate local multiscale signal structure.

Normalization

In keeping with preferred aspect of the invention, input processor 210 preferably normalizes variations peak magnitude by dividing each spectrum of the data cube by the area under the spectrum. Each 50-channel spectrum is interpolated using a 128-point cubic spline function whereupon the area under the curve is estimated by integrating the spline function. Each component of the original spectrum is then divided by the computed area to obtain the normalized spectrum. Input processor 210 preferably calibrates all data for instrument gains and offsets prior to area normalization. While the preceding is a preferred method of normalization, input processor 210 may employ any suitable normalization method.

FIGS. 5A and 5B illustrate the effect of area normalization on CIN1 samples from two patients aaOOO3 and aa0O28. FIG. 5A shows mean CIN1 spectra for both patients before area normalization. Note the significant difference in peak magnitude. FIG. 5B shows mean CIN1 spectra for both patients after area normalization. Note how most of the difference in peak magnitude has been removed when compared with FIG. 5A. Area normalization forces consideration of shape features that are invariant with respect to spectral magnitude. This is desirable since unnormalized spectral magnitude will vary considerably between different cervical tissue classes, hyperspectral imagers and patients. Such variation if not removed makes the design and implementation of a robust and accurate pattern recognition system very difficult.

Extraction

Once the spectra have been normalized, image processor 210 extracts features of the spectra that are particularly useful in discriminating normal cervix tissue from diseased cervix tissue. A preferred method for extracting spectral components is the expansion/compression (E/C) paradigm. By way of explanation, the E/C paradigm first expands the input signal in some transform domain and then compresses the resulting expansion for presentation to a classifier, such as, classifier 250. The expansion phase separates the signal from noise and “pre-whitens” non-stationary and non-Gaussian noise backgrounds (e.g., factual noise) for improved signal-to-noise ratio (SNR). In preferred embodiments, the expansion phase of the E/C paradigm is realized using continuous wavelet transform (CWT) techniques. CWT is multiresolution and provides a high degree of signal/noise separation and background equalization. Moreover, the redundancy of the CWT provides a signal representation that is visually appealing and easily interpretable.

It is believed that the noise background of a signal is better conditioned in the wavelet domain and, therefore, it is expected that better pattern recognition features are obtained by compressing the wavelet transform of the signal rather than the signal itself. In a preferred embodiment, input processor 210 performs the compression phase of the E/C paradigm using Principal Component Analysis (PCA) based on the Singular Value Decomposition (SVD) of the wavelet data matrix. PCA decorrelates the wavelet coefficients over time and scale, removes the wavelet-conditioned noise background, and reduces the dimensionality of the feature vector that is presented to classifier 250 as input. PCA compression in the wavelet domain results in features known as principal wavelet components (PWC). Input processor 210 preferably employs SVD to implement PCA because it operates directly on the wavelet data matrix and precludes the need to compute the data covariance matrix, which can be numerically unstable. However, in alternate embodiments, other techniques known to those of skill in the art may be by input processor 210 employed to implement PCA.

A significant advantage of wavelet analysis is that it captures both global and local features of the spectral signal. Global features such as the peak magnitude of the spectral hump 110 illustrated in FIG. 1C are captured by low-resolution wavelets of large time duration. Small local variations at differing scales that ride along spectral hump 110 are captured by high-resolution wavelets of small time duration. The CWT acts like a signal processing microscope, zooming in to focus on small local features and then zooming out to focus on large global features. The result is a complete picture of all signal activity, large and small, global and local, low frequency and high frequency.

In operation, input processor 210 derives wavelets at different scales of resolution from a single “mother” wavelet function. The preferred mother wavelet is based on the 5^{th} derivative of the Gaussian distribution. The CWT based on this mother wavelet is equivalent to taking the 5th derivative of the signal smoothed at multiple scales of resolution that is, the CWT defined for input processor 210 is a multiscale differential operator. The CWT of input processor 210 essentially characterizes regions of significant high-order spectral activity at multiple scales of resolution all along the spectral profile. It is believed that this property of the CWT results in enhanced detection of cervical dysplasia by classifier 250.

To further explain the operation of input processor 210, first, the mother wavelet of input processor 210 is defined. Let d be the Gaussian distribution of zero mean and unit variance defined by

$$φ ( u ) = \frac{{e}^{- {u}^{z} / 2}}{\sqrt{2 π}} \qquad ( 1 )$$

where uε [symbol] is a real number. Then φ is n-times differentiable for any positive integer n and

$${lim }_{u \to \pm ∞} {φ}^{( n - 1 )} ( u ) = 0 \qquad ( 2 )$$

where φ⁽ⁿ⁾ is the nth derivative of φ. Let ψⁿ be defined by

ψ⁽ⁿ⁾(u)≡(−1)ⁿφ⁽ⁿ⁾(u).

Then by equation (2) we have

$${\int }_{- ∞}^{∞} {ψ}^{n} ( u ) ⅆ u = {( - I )}^{n} [ {φ}^{( n - 1 )} ( ∞ ) - {φ}^{( n - 1 )} ( - ∞ ) ] = 0. \qquad ( 4 )$$

It follows from equation (4) that Ψⁿ satisfies the admissibility condition for wavelets and can be used as a mother wavelet to define a CWT that is invertible.

A wavelet analysis of signals is obtained by looking at them through scaled and translated versions of Ψⁿ. For scale s≠0 and time tε [symbol] , let

$${ψ}_{s , t}^{n} ( u ) ≡ \vert s {\vert}^{- I} {ψ}^{n} ( \frac{u - t}{s} ) . \qquad ( 5 )$$

The functions Ψⁿ_{s, t} are wavelets obtained by scaling and translating Ψⁿ by s and t, respectively. Note that since the Fourier transform of a Gaussian function is again Gaussian, the wavelet function Ψⁿ_{s, t} is localized in both time and frequency. This means that any signal analysis based on these functions will also be localized in time and frequency. Accordingly, the CWT for image processor 210 may now be defined. For any finite energy signal ƒεL²( [symbol] ) let

$${\tilde{f}}_{n} ( s , t ) ≡ {\int }_{- ∞}^{∞} {ψ}_{s , t}^{n} ( u ) f ( u ) ⅆ u = ⟨ {ψ}_{s , t}^{n} , f ⟩ = {( {ψ}_{s , t}^{n} )}^{*} f \qquad ( 6 )$$

where <. > is the inner product in L²( [symbol] ) and (Ψⁿ_{s, t})* is the adjoint of Ψⁿ_{s, t} when viewed as a linear function on L²( [symbol] ). Then \tilde{ƒ}ₙ(s, t) is the CWT of ƒ at scale s and time t with respect to the mother wavelet Ψⁿ. As a function of t for a fixed scale values, \tilde{ƒ}ₙ(s, t) represents the geometric detail contained in the signal ƒ(t) at the scale s. The smaller scales capture fine geometric detail while the larger scales capture coarser detail. Hence, the CWT provides a means for characterizing both local and global signal features in a single transformation.

The CWT also behaves like a generalized derivative. Let

$${φ}_{s , t} ( u ) ≡ \vert s {\vert}^{- 1} φ ( \frac{u - t}{s} ) \qquad ( 7 )$$

for scale s≠0 and tε [symbol] . Note Φ_{s, t} is a Gaussian distribution with meant t and variance s² (i.e., standard deviation |s|) obtained by scaling and translating the Gaussian function Φ. Define \overline{ƒ}(s, t) by:

$$\overline{f} ( s , t ) ≡ {\int }_{- ∞}^{∞} {φ}_{s , t} ( u ) f ( u ) ⅆ u = ⟨ {φ}_{s , t} , f ⟩ = {φ}_{s , t}^{*} f$$

where Φ*_{s, t} is the adjoint of Φ_{s, t} when viewed as a linear functional on L²( [symbol] ). Note that \overline{ƒ}(s, t) is a local average of ƒ at scale s with respect to the Gaussian kernel Φ_{s, t}.

Now equation (3) implies that

ψ_{s, t}ⁿ=(−1)ⁿsⁿ∂ᵤⁿφ_{s, t}(u)=sⁿ∂ₜⁿφ_{s, t}(u) (8)

where ∂ⁿᵤ and ∂ⁿₜ denote the partial derivatives of Φ_{s, t} with respect to u and t, respectively. Thus

$$\begin{matrix}{\tilde{f}}_{n} ( s , t ) ≡ {\int }_{- ∞}^{∞} {ϕ}_{s , t}^{n} ( u ) f ( u ) ⅆ u \\ = {s}^{n} {\partial }_{t}^{n} {\int }_{- ∞}^{∞} {φ}_{s , t} ( u ) f ( u ) ⅆ u = {s}^{n} {\partial }_{t}^{n} \overline{f} ( s , t ) .\end{matrix} \qquad ( 9 )$$

Equation (9) suggests the CWT of ƒ with respect to Ψ^{t} is proportional (by the factor sⁿ) to the nth derivative of the average of ƒ at scale s, that is, the CWT is a multiscale differential operator. Note the nth derivative of ƒ(t) gives the exact nth order geometric detail of ƒ at time t, i.e., the nth order detail at scale zero. For example, ƒ⁽¹⁾(t) measures the instantaneous slope of ƒ at time t and ƒ²(t) measures the concavity off at time t, both at zero scale. The significance of the CWT is that it first smoothes the signal ƒ with the Gaussian function Φ_{s, t} at some scale s>0 to get \overline{ƒ}(s, t) and then takes the derivative to get \tilde{ƒ}ₙ(s, t). This results in a less noisy differential operator that more accurately characterizes the multiscale edge structure of the signal ƒ.

As mentioned above, in preferred embodiments we set n=5 in equation (3) suggesting that the resulting CWT will ignore features of the spectral signal associated with polynomials of degree 4 and accentuate what remains. FIG. 6 shows the mother wavelet Ψ⁵ (solid line) defined by equation (3) and the wavelet Ψ⁵_{5, 10} (dotted line) which is the mother wavelet scaled by 5 and translated by 10. The extent of Ψ⁵ is effectively confined to the interval (−3, 3) and it represents the smallest wavelet in the family. All the other wavelets of the family, such as Ψ⁵_{5, 10} are stretched and shifted versions of Ψ⁵.

Prior to wavelet transformation, each spectrum is calibrated, area-normalized and truncated preferably at band 40 to reduce the effects of noise from higher order bands. The resulting 40-component spectral signal is interpolated to 128 points using a cubic spline function. For s=1, 2, . . . 32 and t=1,2, . . . 128 we use equation (7) to compute g(s, t)−log₂(|\tilde{ƒ}ₙ(s, t)|²) and stack the vectors g(s, t) one on top of the other, with scale running vertically and time running horizontally to generate a 32×128 image known as a scalogram.

Compression

FIGS. 7A and 7B show wavelet scalograms for spectra corresponding to CIN1 and normal squamous tissue, respectively. Note the detail at the higher order scales that correspond to the finer resolution wavelets. This detail represents the small spectral variations that ride along the spectral hump. Note also the diminished activity for the lower order scale values that correspond to the lower resolution wavelets. This reduced activity represents signal features associated with the slow variation of the spectral hump itself. Each horizontal scan of the scalogram represents the distribution of signal energy over time with respect to a band-pass filter implicitly defined by a fixed scale factor. Each vertical scan represents the signal's energy distribution over a bank of band-pass filters (one filter per scale) with respect to a fixed time.

The scalograms of FIGS. 7A and 7B are composed of 4,096 wavelet coefficients each of which provide a rich but dense signal representation that is too large for direct input to classifier 250, due to the problem of dimensionality; i.e., large neural networks perform badly on small data sets. To address this problem input processor 210 must find a way to compress the wavelet coefficients of the scalogram representation without losing important signal information. Accordingly, input processor 210 performs the steps of bin-averaging in both scale and time to produce a 16×16 representation that is then vertically raster-scanned to a vector with 256 coefficients. FIGS. 8A and 8B show the bin-averaged, raster-scanned wavelet coefficients of spectra corresponding to CIN1 and normal squamous tissue, respectively. FIG. 8C shows the difference between the wavelet vectors for CIN1 and normal squamous tissue. Although, the number of coefficients has been reduced significantly (from 4096 to 256) the dimensionality of the feature vector is still too high. In order to reduce the dimensionality even further input processor 210 may extract principal components of the wavelet data matrix whose columns are the bin-averaged, raster-scanned wavelet coefficients of the spectral time series.

PCA is a classical statistical technique for characterizing the linear correlation that exists in a set of data. One of the primary goals of pattern recognition is to find a linear transformation that maps a vector of noisy, correlated components, i.e., wavelet coefficients of a spectral signal, to a much smaller vector of denoised, uncorrelated principal components. This reduced feature vector is then presented as input to a neural network classifier.

Let A=[x₁, x₂, . . . , xₙ]^{T} be a M×N data matrix whose columns are composed of N noisy data vectors xᵢ of length M with correlated components (where superscript T is the matrix transpose operator). A linear transformation P is desired such that the vector yᵢ=Pxᵢ has uncorrelated, denoised components and length K much smaller than M (i.e., K<<M). Now PCA produces an orthogonal matrix V and a diagonal matrix D such that AA^{T}=VDV^{T}. Note that AA^{T} is essentially the M×M sample covariance matrix of the data set {x₁, x₂, . . . , xₖ}. The columns of V are the eigenvectors of AA^{T} and they form an orthonormal basis for [symbol] ^{M} while the diagonal entries of D are the eigenvalues λ₁ of AA^{T} and are ordered so that λⱼ>λⱼ₊₁ for j=1, 2, . . . , M−1. Now choose the eigenvectors of V that correspond to the K largest eigenvalues where K<<M and form the matrix \tilde{V} whose columns are equal to these eigenvectors. Then P=\tilde{V}^{T} is the linear transformation we seek because the principal component vector yᵢ=Pxᵢ has length K<<M, and components that are uncorrelated (since the eigenvectors of V are orthonormal) and denoised (since the discarded eigenvectors are assumed to span the noise subspace). With hyperspectral data, care must be taken to ensure that important information is not lost by discarding the higher-order eigenvectors. Usually though, a visual analysis of a plot of the eigenvalues makes it clear where signal ends and noise begins.

FIG. 9A illustrates a plot of the 256 eigenvalues obtained for a typical HSDI data set composed of spectral samples from twelve different patients and five tissue classes. PCA was applied to the 256×1345 wavelet data matrix. Each column of wavelet data matrix is a vector of 256 wavelet coefficients for a spectral sample. Note how quickly the eigenvalues decrease in magnitude. This means a fair amount of data reduction is possible without losing important signal information. For example, about 85% of all the variation in the data is captured by the eigenvectors corresponding to the top 15 eigenvalues. Numerical experiments show that optimal classification accuracy is obtained when the first 10-15 PWCs are used. Hence, a significant reduction in classifier input vector size is realized in going from 256 wavelet coefficients down to, e.g., 10 PWC components. FIG. 9B shows the top 15 PWC features for typical CIN1 and normal squamous spectra. To the extent that the training data truly represents the universe of possibilities, the retained eigenvectors used to compute PWC features will enable classifier 250 to generalize to new data encountered in real-world clinical settings.

In keeping with the invention, input processor 210 implements PCA by taking the SVD of the wavelet data matrix. Since SVD operates directly on the wavelet data matrix, computation of the sample covariance matrix is unnecessary and the final result is more numerically stable than standard PCA. If A is an M×N matrix, then SVD says there are orthogonal matrices U and V and a diagonal matrix Σ=[σᵢ] such that A=UΣV^{T} where U is M×M, V is N×N, and Σ has the same dimensions as A. The columns of U and V are known as the left and right singular vectors of A, respectively, while the diagonal elements σ₁ of Σ are called the singular values of A. Note the eigenvectors of AA^{T} are the columns of U, and the eigenvalues of AA^{T} are related to singular values of A by λ₁=σ²ᵢ. If input processor 210 constructs the matrix Ũ composed of left singular column vectors of U corresponding to the K largest eigenvalues, then the PWC feature vector y of data vector x is composed by y=Px where P=Ũ^{T}.

Classification

Classifier 250 receives the PWC features extracted from the annotated spectra as input data and classifies each pixel according to one of the previously defined cervical tissue classes. In accordance with a preferred aspect of the invention, classifier 250 is a neural network. More preferably, classifier 250 is a multilayer perception (MLP) neural network. The preferred classifier 250 employs hyperbolic tangent activation functions for the hidden nodes and logistic activations for the output nodes.

In order for classifier 250 to discriminate pixels, it must be trained to recognize the desired tissue classes. In training classifier 250, an image of the cervix is annotated to identify the various tissue classes present. The tissue classes may be identified by taking biopsies of suspicious lesions and having a pathologist make a diagnosis. An operator may then use the diagnoses to annotate the image of the cervix using known image manipulation techniques. A region on the cervix may be annotated by assigning it a class label which corresponds to one of the following diagnoses: CIN1, CIN2, CIN3, squamous cell carcinoma, adenomatous neoplasia including adenocarcinoma-in-situ and invasive adenocarcinoma, normal squamous tissue, normal columnar tissue and normal metaplasia. Some regions of the cervix may be annotated by visual inspection at colposcopy when it is obvious to he medical specialist what tissue class is involved. The spectra from the annotated regions are used to train and test classifier 250. When classifier 250 is appropriately trained, it assigns a unique class label to unknown spectral signals to avoid classification error.

In performing discrimination, classifier 250 preferably outputs a signal of magnitude of about 0.9 for the node associated with the target class and about 0.1 for the remaining output nodes. Classifier 250 preferably has a separate output for each tissue classification. In accordance with a first embodiment, classifier 250 comprises a neural network having five output nodes, each output node corresponding to a respective tissue class, or a five class neural network. Specifically, the output nodes preferably correspond to the following tissue classes: CIN1, squamous, columnar, and metaplasia, plus a class for other unspecified tissue types, which may include blood and mucus. In a second embodiment, classifier 250 comprises a neural network having two output nodes, each output node corresponding to a defined tissue class, or a two class neural network. The two class neural network is particularly useful to distinguish between CIN1 and a class of normal tissue. The normal class comprises a combination of data from the squamous, columnar, metaplasia and “other” classes discussed above.

Classifier 250 may be trained using the Levenberg-Marquardt algorithm and the output nodes may be smoothed using Bayesian regularization. When the mean-squared-error on test data begins to increase, training is stopped. The combination of Bayesian smoothing and early stopping prevents over-training and poor generalization of test data.

Once classifier 250 has been trained, the system according to the invention may be employed to generate a histological map of the entire surface of the cervix. That is, as described above, image processor 210 extracts PWC features from the data cube and sends those features to classifier 250. Classifier 250 receives the extracted PWC features as input and generates an output for each pixel indicative of the tissue classification to which the pixel belongs. Image processor 270 receives the output from classifier 250 and generates a two-dimensional image having regions that may be color-coded according to tissue classification. The images generated according to this invention accurately show at a glance, the distribution of dysplasic tissue over the surface of the cervix. FIG. 10A illustrates an exemplary color-coded image in accordance with the invention. In the depicted image, CIN1 pixels are bright (red to yellow), likely normal pixels are dark (blue) and other pixels are somewhere in between. However, other color-coding schemes may be employed. The color-coded image may be passed through an image processor 270 to filter the image such that the image reveals only two conditions, CIN1 and normal. For example, CIN1 pixels may be depicted in white and normal pixels may be depicted in black as illustrated in FIG. 10B. The image processor 270 transmits the two dimensional image to display 290 where the image may be viewed by a medical specialist.

The entire image generation process, including cervical scan and image creation, takes only a matter of seconds. Accordingly, the present invention allows the medical specialist to accurately and reliably both detect the presence of cancerous and/or non-cancerous cervical tissue while the patient is present, in a non-invasive manner. This is a significant advantage over presently employed colposcopic procedures that are intrusive, painful and require highly skilled physicians for administration.

What is claimed is:

1. An apparatus for generating a two dimensional histological map of a cervix from a 3-dimensional hyperspectral data cube generated by scanning the cervix comprising:
an input processor constructed to:
normalize fluorescence spectral signals collected from the hyperspectral data cube,
extract pixel data from the spectral signals that is indicative of cervical tissue classification, and
compress the extracted pixel data;
a classifier in communication with said input processor that assigns a tissue classification to the pixel data; and
an image processor in communication with said classifier that generates a two dimensional image of the cervix from the pixel data, said two dimensional image including color-coded regions representing specific tissue classifications of the cervix.

2. An apparatus for generating a two dimensional histological map of a cervix from a 3-dimensional hyperspectral data cube generated by scanning the cervix comprising:
means for normalizing fluorescence spectral signals collected from the hyperspectral data cube;
means for extracting pixel data from the spectral signals, the pixel data being indicative of cervical tissue classification;
means for compressing the extracted pixel data;
means for assigning tissue classifications to the compressed data; and
means for generating a two dimensional image of the cervix from the compressed data, the two dimensional image including color-coded regions representing specific tissue classifications of the cervix.

3. A method for generating two dimensional image of a cervix from a three dimensional hyperspectral data cube generated by scanning the cervix, comprising:
normalizing fluorescence spectral signals collected from the hyperspectral data cube;
extracting pixel data from the spectral signals, the pixel data being indicative of cervical tissue classification;
compressing the extracted pixel data;
assigning tissue classifications to the compressed data; and
generating a two dimensional image of the cervix from the compressed data, the two dimensional image including color-coded regions representing specific tissue classifications of the cervix.

4. An article of manufacture comprising:
a computer usable medium having computer program code embodied therein for generating a two dimensional image of a cervix from a three dimensional hyperspectral data cube including:
a program code segment for causing a computer to normalize fluorescence spectral signals collected from the hyperspectral data cube;
a program code segment for causing the computer to extract pixel data from the spectral signals, the pixel data being indicative of cervical tissue classification;
a program code segment for causing the computer to compress the extracted pixel data;
a program code segment for causing the computer to assign tissue classifications to the compressed data; and
a program code segment for causing the computer to generate a two dimensional image of the cervix from the compressed data, the two dimensional image including color-coded regions representing specific tissue classifications of the cervix.
